(19) United States
(12) Patent Application Publication
(10) Pub. No.: US 2025/0132595 A1
(43) Pub. Date: Apr. 24, 2025

(54) VEHICLE BATTERY JUMP STARTER POWERED BY A REMOVABLE AND RECHARGEABLE BATTERY PACK

(71) Applicant: MILWAUKEE ELECTRIC TOOL CORPORATION, Brookfield, WI (US)

(72) Inventor: Austin A. Borkowski, Greendale, WI (US)

(21) Appl. No.: 18/924,582

(22) Filed: Oct. 23, 2024

Related U.S. Application Data
(60) Provisional application No. 63/592,439, filed on Oct. 23, 2023.

(51) Int. Cl. H02J 7/34; H01M 10/44; H01M 10/46; H02J 7/00

(52) U.S. Cl. CPC H02J 7/342; H01M 10/44; H01M 10/46; H02J 7/00036; H02J 7/0045; H02J 7/0047; H02J 7/007182; H01M 2220/20

(57) ABSTRACT

A vehicle battery jump starter that is powered by a removable and rechargeable battery pack, such as a battery pack used with various hand-held power tools. The battery pack removably connects to a vehicle battery jump starter and can be selectively used to charge a power boost module within the vehicle battery jump starter. The power boost module includes, for example, a plurality of supercapacitors or lithium polymer battery cells. The power boost module in combination with the battery pack 100 are used to jump start a vehicle battery. The vehicle battery jump starter includes a charge control circuit configured to control charging of the power boost module based upon battery information obtained from the battery pack.

### RELATED APPLICATIONS

This application claims the benefit of, and priority to, U.S. Provisional Patent Application No. 63/592,439, filed Oct. 23, 2023, the entire content of which is hereby incorporated by reference.

### BACKGROUND

The present invention relates to a vehicle battery jump starter powered by a removable and rechargeable battery pack.

### SUMMARY

Vehicle battery jump starters are subject to a number of design limitations that make the implementation of a vehicle battery jump starter difficult. For example, the vehicle battery jump starter must satisfy requirements related to voltage magnitudes (e.g., vehicle battery overvoltage), power source undervoltage (e.g., jump starter power source undervoltage), sparking and short circuiting, and electrical current magnitude. As a result of these limitations, current vehicle battery jump starters are dedicated devices with internal power sources that can be charged and then used as necessary to jump start a vehicle. These jump starters may include a sealed lead acid battery, a plurality of lithium polymer batteries, or a bank of supercapacitors. Such devices are often charged from AC mains power. However, because AC mains power is not always readily available, it is possible that, in an emergency, the vehicle battery jump starters may lack sufficient charge to jump start a vehicle battery. A depleted vehicle battery can be used to slowly charge a bank of supercapacitors, but the bank of supercapacitors alone may not always be sufficient to jump start the vehicle battery.

As an alternative to these conventional vehicle battery jump starters, a vehicle battery jump starter that could be powered by a battery pack for cordless, hand-held power tools would greatly enhance the versatility of vehicle battery jump starters. Such a jump starter could be used anywhere at any time as long as a battery pack is available. One of the difficulties in implementing a vehicle battery jump starter powered by a battery pack for power tools is the magnitude of current that the battery pack is capable of producing. Electrical current limitations of battery packs in the context of vehicle battery jump starters can be mitigated or removed if the battery pack is first used to charge a bank of supercapacitors or lithium polymer battery cells. After the supercapacitors or lithium polymer battery cells are charger, current can be discharged from both the battery pack and the supercapacitors or lithium polymer battery cells. The battery pack discharge current in combination with discharge current from the supercapacitors or lithium polymer battery cells can be sufficient to jump start a vehicle battery. In some situations, just as a depleted vehicle battery can be used to charge a bank of supercapacitors, a depleted battery pack could be used alone or in conjunction with a depleted vehicle battery to charge the bank of supercapacitors. The bank of supercapacitors could then be used to attempt to jump start the vehicle battery.

In some aspects, the techniques described herein relate to a vehicle battery jump starter device including a controller including an electronic processor and a charge control circuit, a battery pack interface configured to receive a removable and rechargeable battery pack, a power boost module including one or more energy storage devices, wherein the power boost module is configured to be charged through the battery pack interface with a discharge current from the removable and rechargeable battery pack, wherein the charge control circuit is configured to control the discharge current from the removable and rechargeable battery pack to the power boost module based upon one or more monitored conditions of the removable and rechargeable battery pack.

In some aspects, the techniques described herein relate to a device, wherein the charge control circuit is configured to measure a no-load voltage of the removable and rechargeable battery pack and calculate an allowable load voltage threshold based on a measured no-load voltage. In some aspects, the techniques described herein relate to a device, wherein the charge control circuit is configured to control the discharge current from the removable and rechargeable battery pack to the power boost module to maintain a voltage of the removable and rechargeable battery pack above an allowable load voltage threshold.

In some aspects, the techniques described herein relate to a device, wherein the charge control circuit is configured to modulate the discharge current to maintain the voltage of the removable and rechargeable battery pack at or above the allowable load voltage threshold.

In some aspects, the techniques described herein relate to a device, wherein the charge control circuit calculates the allowable load voltage threshold based upon a type of removable and rechargeable battery pack, the type of removable and rechargeable battery pack including a high impedance battery pack or a low impedance battery pack. In some aspects, the techniques described herein relate to a device, wherein the charge control circuit determines the type of removable and rechargeable battery pack based on battery information communicated from the battery pack.

In some aspects, the techniques described herein relate to a device, wherein the charge control circuit determines the type of removable and rechargeable battery pack based on monitored discharge characteristics of the battery pack. In some aspects, the techniques described herein relate to a device, wherein the controller is configured to prevent the removable and rechargeable battery pack from being used to jump start the vehicle battery if a voltage of the removable and rechargeable battery pack is below a second allowable voltage threshold. In some aspects, the techniques described herein relate to a device, wherein the power boost module includes a plurality of supercapacitors and wherein the power boost module includes a plurality of lithium-polymer battery cells.

In some aspects, the techniques described herein relate to a method of jump starting a vehicle battery using a vehicle battery jump starter and a removable and rechargeable battery pack, the method including electrically connecting the removable and rechargeable battery pack to a power boost module within the vehicle battery jump starter, determining, via a first electronic processor of the removable and rechargeable battery pack, one or more parameters of the removable and rechargeable battery pack, charging, via the first electronic processor, the power boost module using power from the removable and rechargeable battery pack based on the determined parameters, electrically disconnecting, via the first electronic processor, the removable and rechargeable battery pack from the power boost module after the power boost module is charged, electrically connecting the vehicle battery jump starter to the vehicle battery, monitoring, via a second electronic processor, a voltage of the vehicle battery, and providing power, via the second electronic processor, from the charged power boost module to the vehicle battery in response to the voltage of the vehicle battery indicating an attempt to start the vehicle.

In some aspects, the techniques described herein relate to a method, further including: preventing, via the second electronic processor, the removable and rechargeable battery pack from being used to jump start the vehicle battery if the voltage of the removable and rechargeable battery pack is below a voltage threshold. In some aspects, the techniques described herein relate to a method, wherein determining the one or more parameters of the connected removable and rechargeable battery pack includes measuring a no-load voltage of the removable and rechargeable battery pack, and calculating, via the first electronic processor, an allowable load voltage threshold based on the measured no-load voltage.

In some aspects, the techniques described herein relate to a method, further including: controlling, via the first electronic processor, a discharge current from the removable and rechargeable battery pack to the power boost module to maintain the voltage of the removable and rechargeable battery pack above the allowable load voltage threshold. In some aspects, the techniques described herein relate to a method, further including: modulating, via the first electronic processor, the discharge current to maintain the voltage of the removable and rechargeable battery pack at or above the allowable load voltage threshold.

In some aspects, the techniques described herein relate to a battery pack powered vehicle battery jump starter system, the system including a removable and rechargeable battery pack including a battery pack housing, a plurality of rechargeable battery cells within the battery pack housing; a support portion for supporting the battery pack on the vehicle battery jump starter, a coupling mechanism for selectively electrically coupling the battery pack to the vehicle battery jump starter, and a battery pack controller within the battery pack housing the battery pack controller configured to control an operation of the removable and rechargeable battery pack. The system further includes a vehicle battery jump starter including a jump starter housing, a support portion for receiving and coupling the removable and rechargeable battery pack to the vehicle battery jump starter, a plurality of terminals for electrically connecting the removable and rechargeable battery pack to the vehicle battery jump starter, and a jump starter controller within the jump starter housing, the jump starter controller configured to control an operation of the vehicle battery jump starter, wherein the jump starter controller controls the vehicle battery jump starter to jump start a vehicle in response to the battery pack controller controlling an operation of the removable and rechargeable battery pack.

In some aspects, the techniques described herein relate to a system, wherein the battery pack controller is configured to communicate battery pack information to the jump starter controller, and the jump starter controller is configured to use the communicated battery pack information to control the operation of the vehicle battery jump starter, and wherein the battery pack information includes at least one of a battery capacity level, a battery impedance level, a battery age, a battery temperature, a battery voltage level, a number of battery charge/discharge cycles, a number of battery usages, or a number of battery overtemperature events.

In some aspects, the techniques described herein relate to a system, wherein the jump starter controller is configured to monitor discharge characteristics of the removable and rechargeable battery pack during operation of the vehicle battery jump starter and predict a discharge rate of the removable and rechargeable battery pack based on the monitored discharge characteristics. In some aspects, the techniques described herein relate to a system, wherein the jump starter controller is configured to adjust performance of the vehicle battery jump starter in response to a monitored voltage of the removable and rechargeable battery pack being below an allowable load voltage threshold, and wherein adjusting the performance includes at least one of reducing power draw, extending run time, or modifying performance of a power boost module within the vehicle battery jump starter.

In some aspects, the techniques described herein relate to a system, wherein the jump starter controller is configured to prevent the removable and rechargeable battery pack from being used to jump start a vehicle battery in response to a voltage of the removable and rechargeable battery pack being below a second allowable voltage threshold.

In some aspects, the techniques described herein relate to a system, wherein the vehicle battery jump starter further includes a power boost module having one or more energy storage devices, wherein the jump starter controller is configured to charge the power boost module using power from the removable and rechargeable battery pack, and wherein the jump starter controller controls the charging of the power boost module based on one or more parameters of the removable and rechargeable battery pack.

Before any embodiments of the invention are explained in detail, it is to be understood that the invention is not limited in its application to the details of the configuration and arrangement of components set forth in the following description or illustrated in the accompanying drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components may be utilized to implement the invention. For example, “servers” and “computing devices” described in the specification can include one or more processing units, one or more computer-readable medium modules, one or more input/output interfaces, and various connections (e.g., a system bus) connecting the components.

Other aspects of the invention will become apparent by consideration of the detailed description and accompanying drawings.

### BRIEF DESCRIPTION OF THE DRAWINGS

FIG. 1 is a perspective view of a battery pack, according to an embodiment of the invention.

FIG. 2 is a top view of the battery pack of FIG. 1.

FIG. 3 is a section view of the battery pack of FIG. 1 showing battery cells, according to an embodiment of the invention.

FIG. 4 is an electromechanical diagram of the battery pack of FIG. 1, according to an embodiment of the invention.

FIG. 5 illustrates a vehicle battery jump starter configured to receive, support, and be powered by the battery pack of FIG. 1, according to an embodiment of the invention.

FIG. 6 is an electromechanical diagram of the vehicle battery jump starter of FIG. 5, according to an embodiment of the invention.

FIG. 7 is a process for jump starting a vehicle battery using the vehicle battery jump starter of FIG. 5 being powered by the battery pack of FIG. 1, according to an embodiment of the invention.

### DETAILED DESCRIPTION

This invention relates to a vehicle battery jump starter that is powered by a removable and rechargeable battery pack, such as a battery pack used with various hand-held power tools. The battery pack removably connects to a vehicle battery jump starter. The battery pack, or a plurality of battery packs connected together, can be used to power the vehicle battery jump starter and jump start a vehicle battery. The battery pack can also be selectively used to charge a power boost module within the vehicle battery jump starter. The power boost module includes, for example, a plurality of supercapacitors or lithium polymer battery cells. The power boost module in combination with the removable and rechargeable battery pack are used to jump start a vehicle battery.

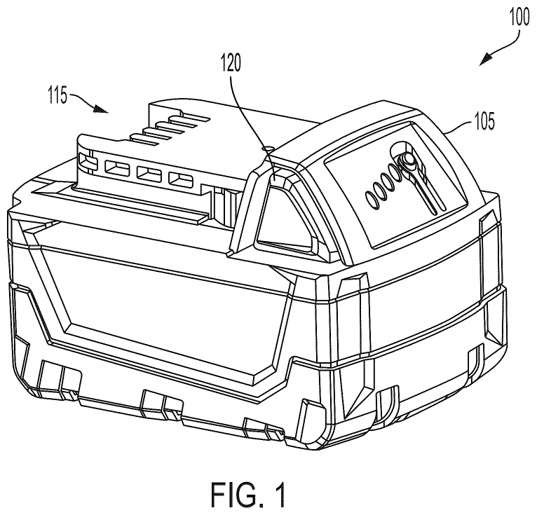

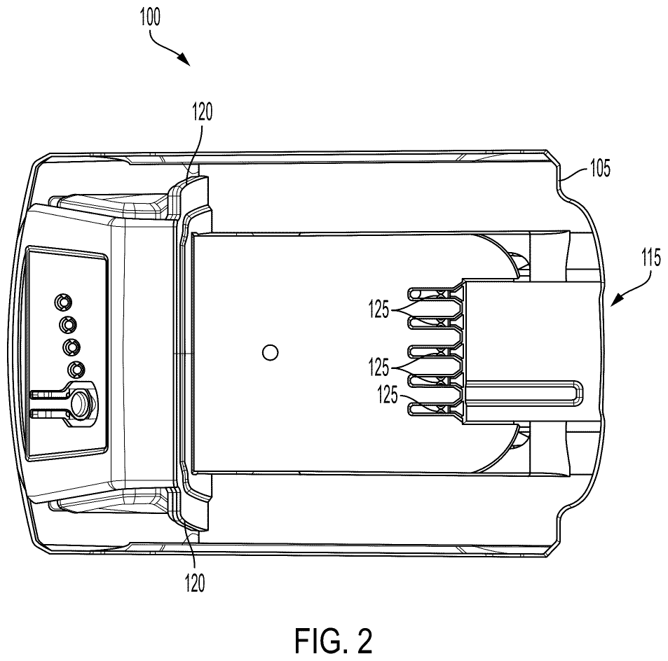

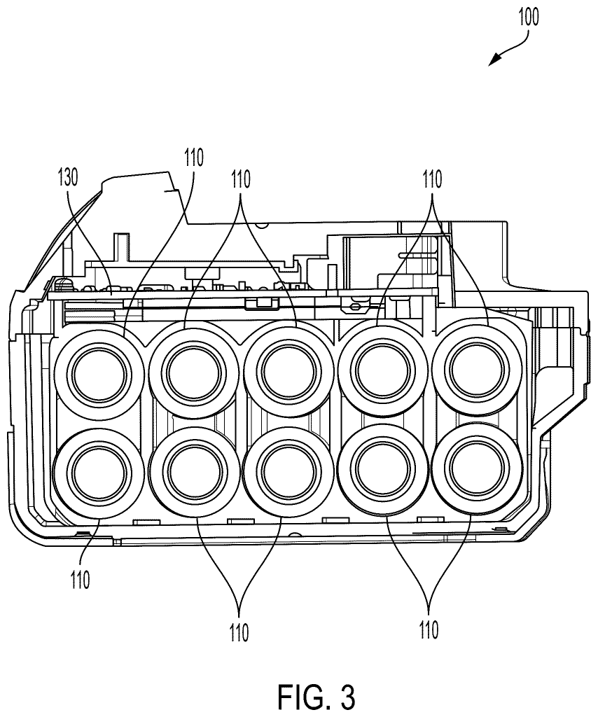

FIGS. 1-3 illustrate a battery pack 100 for use with a vehicle battery jump starter, also referred to as a battery pack powered vehicle battery jump starter system. The battery pack 100 is connectable to and supportable by hand-held power tools such as drills, fasteners, saws, pipe cutters, sanders, nailers, staplers, vacuum cleaners, etc. The battery pack 100 is also connectable to and supportable by outdoor power tools such as string trimmers, hedge trimmers, blowers, chain saws, etc. As shown in FIGS. 1-3, the battery pack 100 includes a housing 105 and at least one rechargeable battery cell 110 (shown in FIG. 3) supported by the housing 105. The battery pack 100 also includes a support portion 115 for supporting the battery pack 100 on a tool, and a coupling mechanism 120 for selectively coupling the battery pack 100 to, or releasing the battery pack 100 from, the tool. The support portion 115 is connectable to a complementary support portion on the tool.

The battery pack 100 includes a plurality of terminals 125 located within the support portion 115 and operable to electrically connect the battery cells 110 to a PCB 130 within the battery pack 100. The plurality of terminals 125 includes, for example, a positive battery terminal, a ground terminal, and a sense or data terminal. The battery pack 100 is removably and interchangeably connected to a tool to provide operational power to the tool. The terminals 125 are configured to mate with corresponding power terminals extending from a tool within a complementary receiving portion or the tool.

The illustrated battery pack 100 includes ten battery cells 110. In other embodiments, the battery pack 100 can include additional or fewer battery cells 110. The battery cells can be arranged in series, parallel, or a series-parallel combination. For example, the battery pack can include a total of ten battery cells configured in a series-parallel arrangement of five sets of two series-connected cells. The series-parallel combination of battery cells allows for an increased voltage and an increased capacity of the battery pack. In some embodiments, the battery pack 100 includes five series-connected battery cells. In other embodiments, the battery pack 100 includes a different number of battery cells (e.g., between three and thirty battery cells) connected in series, parallel, or a series-parallel combination in order to produce a battery pack having a desired combination of nominal battery pack voltage and battery capacity.

The battery cells 110 are lithium-based battery cells having a chemistry of, for example, lithium-cobalt (“Li—Co”), lithium-manganese (“Li—Mn”), or Li—Mn spinel. In some embodiments, the battery cells 110 have other suitable lithium or lithium-based chemistries, such as a lithium-based chemistry that includes manganese, etc. The battery cells within the battery pack 100 provide operational power (e.g., voltage and current) to the tools. In one embodiment, each battery cell 110 has a nominal voltage of approximately 3.6V, such that the battery pack has a nominal voltage of approximately 18V. In other embodiments, the battery cells have different nominal voltages, such as, for example, between 3.6V and 4.2V, and the battery pack has a different nominal voltage, such as, for example, 10.8V, 12V, 14.4V, 24V, 28V, 36V, 60V, 80V, between 10.8V and 80V, etc. The battery cells 110 also each have a capacity of, for example, approximately between 1.0 ampere-hours (“Ah”) and 6.0 Ah. In exemplary embodiments, the battery cells each have capacities of approximately, 1.5 Ah, 2.4 Ah, 3.0 Ah, 4.0 Ah, 6.0 Ah, between 1.5 Ah and 6.0 Ah, etc. In some embodiments, a battery pack 100 having a total battery pack capacity of approximately 5.0 Ah or greater (e.g., 5.0 Ah to 12.0 Ah) is used in combination with a vehicle battery jump starter. In other embodiments, a battery pack 100 having a total battery pack capacity of approximately 1.5 Ah or greater (e.g., 1.5 Ah to 12.0 Ah) is used in combination with a vehicle battery jump starter.

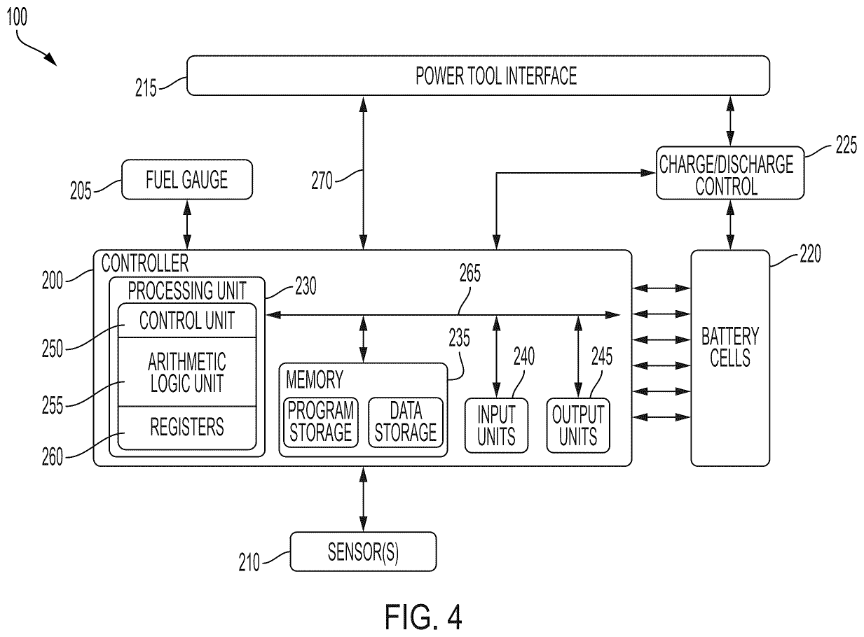

The power output by the battery pack 100 to a tool is controlled, monitored, and regulated using control electronics within the battery pack 100, a tool, or a combination thereof. FIG. 4 illustrates a controller 200 associated with the battery pack 100. The controller 200 is electrically and/or communicatively connected to a variety of modules or components of the battery pack 100. For example, the illustrated controller 200 is connected to a fuel gauge 205, one or more sensors 210, a tool interface 215, a plurality of battery cells 220, and a charge/discharge control module 225 (optional within battery pack). The controller 200 includes combinations of hardware and software that are operable to, among other things, control the operation of the battery pack 100, activate the fuel gauge 205, monitor the operation of the battery pack 100, etc. The fuel gauge 205 includes, for example, one or more indicators, such as light-emitting diodes (“LEDs”). The fuel gauge 205 can be configured to display conditions of, or information associated with, the state-of-charge of the battery cells 220. The controller 200 also includes a variety of preset or calculated fault condition values related to temperatures, currents, voltages, etc., associated with the operation of a tool.

In some embodiments, the controller 200 includes a plurality of electrical and electronic components that provide power, operational control, and protection to the components and modules within the controller 200 and/or battery pack 100. For example, the controller 200 includes, among other things, a processing unit 230 (e.g., an electronic processor, a microprocessor, a microcontroller, or another suitable programmable device), a memory 235, input units 240, and output units 245. The processing unit 230 includes, among other things, a control unit 250, an arithmetic logic unit (“ALU”) 255, and a plurality of registers 260 (shown as a group of registers in FIG. 4), and is implemented using a known computer architecture, such as a modified Harvard architecture, a von Neumann architecture, etc. The processing unit 230, the memory 235, the input units 240, and the output units 245, as well as the various modules connected to the controller 200 are connected by one or more control and/or data buses (e.g., common bus 265). The control and/or data buses are shown generally in FIG. 4 for illustrative purposes. The use of one or more control and/or data buses for the interconnection between and communication among the various modules and components would be known to a person skilled in the art in view of the invention described herein. In some embodiments, the controller 200 is implemented partially or entirely on a semiconductor (e.g., a field-programmable gate array [“FPGA”] semiconductor) chip, such as a chip developed through a register transfer level (“RTL”) design process.

The memory 235 is a non-transitory computer readable medium that includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processing unit 230 is connected to the memory 235 and executes software instructions that are capable of being stored in a RAM of the memory 235 (e.g., during execution), a ROM of the memory 235 (e.g., on a generally permanent basis), or another non-transitory computer readable medium such as another memory or a disc. Software included in the implementation of the battery pack 100 can be stored in the memory 235 of the controller 200. The software includes, for example, firmware, one or more applications, program data, filters, rules, one or more program modules, and other executable instructions. The controller 200 is configured to retrieve from memory and execute, among other things, instructions related to the control of the battery pack described herein. The controller 200 can also store various battery pack parameters and characteristics (including battery pack nominal voltage, chemistry, battery cell characteristics, maximum allowed discharge current, maximum allowed temperature, etc.). In other constructions, the controller 200 includes additional, fewer, or different components.

The tool interface 215 includes a combination of mechanical components (e.g., the support portion 115) and electrical components (e.g., the plurality of terminals 125) configured to, and operable for, interfacing (e.g., mechanically, electrically, and communicatively connecting) the battery pack 100 with a tool or another device. For example, power provided from the battery pack 100 to a tool or device is provided through the charge/discharge control module 225 to the tool interface 215. The charge/discharge control module 225 includes, for example, one or more switches (e.g., FETs) for controlling the charging current to and discharge current from the battery cells 220. In some embodiments, power provided from the battery pack 100 to a tool or device (or from a charger) is controlled by a charge/discharge control module 225 that is external to the battery pack 100 (i.e., internal to a tool, device, or charger). The tool interface 215 also includes, for example, a communication line 270 for providing a communication line or link between the controller 200 and a tool or device (e.g., a vehicle battery jump starter).

The sensors 210 include, for example, one or more current sensors, one or more voltage sensors, one or more temperature sensors, etc. For example, the controller 200 uses the sensors 210 to monitor an individual state of charge of each of the battery cells 220, monitor a current being discharged from the battery cells 220, monitor the temperature of one or more of the battery cells 220, etc. If the voltage of one of the battery cells 220 is equal to or above an upper voltage limit (e.g., a maximum charging voltage), the charge/discharge control module 225 prevents the battery cells from being further charged or requests that a battery charger (not shown) provide a constant voltage charging scheme. Alternatively, if one of the battery cells 220 falls below a low-voltage limit, the charge/discharge control module prevents the battery cells 220 from being further discharged. Similarly, if an upper or lower operational temperature limit for the battery cells 220 is reached, the controller 200 can prevent the battery pack 100 from being charged or discharged until the temperature of the battery cells 220 or the battery pack 100 is within an acceptable temperature range.

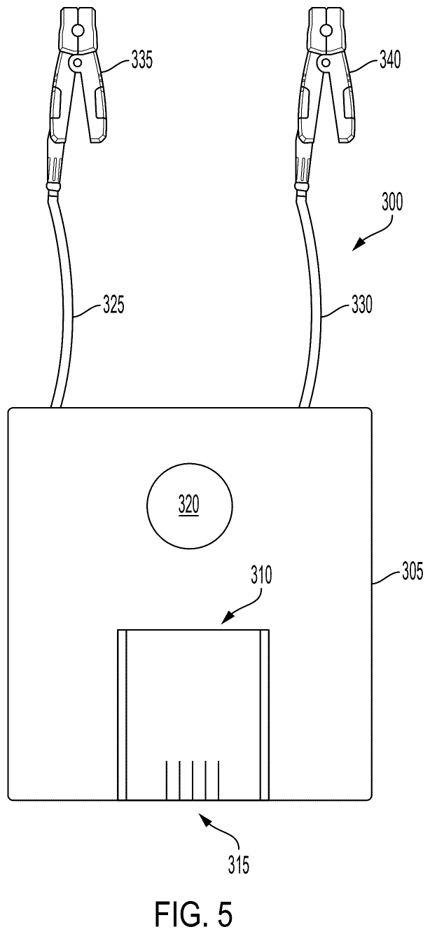

The battery pack 100 is connectable to and supportable by a vehicle battery jump starter such as vehicle battery jump starter 300 illustrated in FIG. 5. The vehicle battery jump starter 300 includes a housing 305, a support portion 310 for receiving and supporting the battery pack 100, a plurality of terminals 315 for electrically connecting the battery pack 100 to the vehicle battery jump starter 300, an ON or POWER button 320 for turning ON or activating the vehicle battery jump starter 300, a first electrical cable 325, a second electrical cable 330, a first terminal clamp 335, and a second terminal clamp 340. The battery pack 100 connects to the vehicle battery jump starter 300 through the support portion 310 and the plurality of terminals 315. As a result, the battery pack 100 operates as a power source for the vehicle battery jump starter 300.

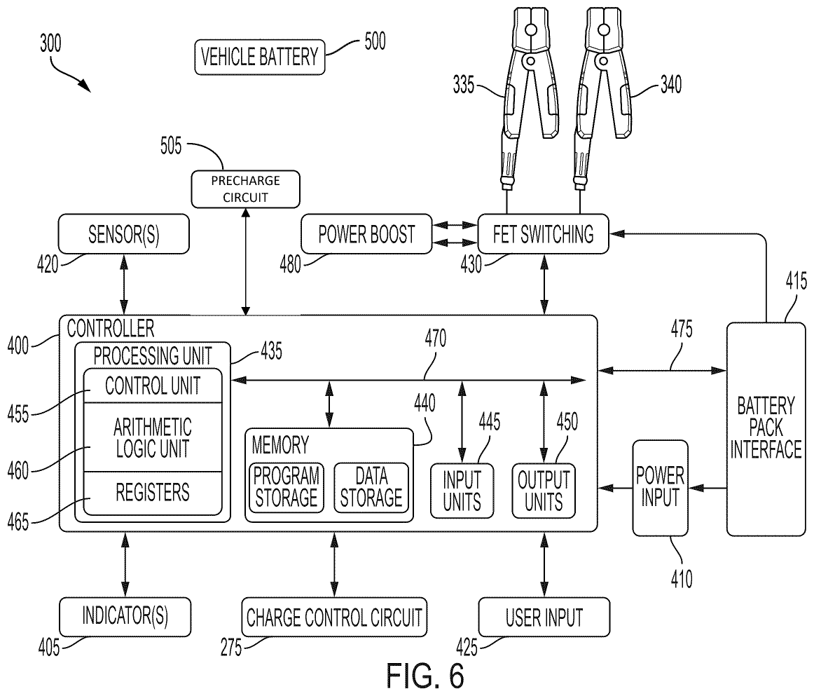

The vehicle battery jump starter 300 includes a controller 400, as shown in FIG. 6. The controller 400 is electrically and/or communicatively connected to a variety of modules or components of the vehicle battery jump starter 300. For example, the illustrated controller 400 is connected to one or more indicators 405, a power input module 410, a battery pack interface 415, one or more sensors 420, a user input module 425, and a FET switching module 430. The controller 400 includes combinations of hardware and software that are operable to, among other things, control the operation of the vehicle battery jump starter 300, activate the one or more indicators 405 (e.g., an LED), monitor the operation of the vehicle battery jump starter 300, etc. The one or more sensors 420 include, among other things, one or more voltage sensors, one or more current sensors, one or more temperature sensors, etc.

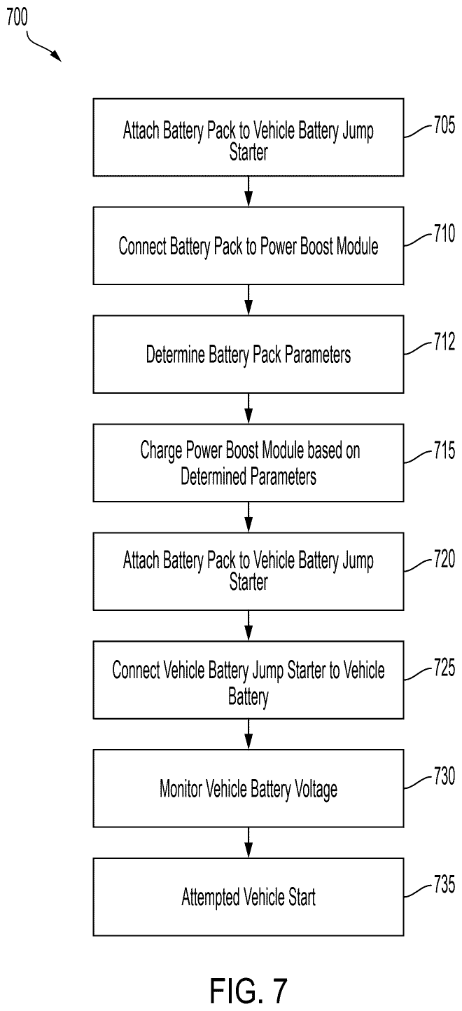

The vehicle battery jump starter 300 additionally includes a precharge circuit 505 controlled by the controller 400. In some embodiments, the precharge circuit 505 connects directly to the charge control circuit 275. In some embodiments, the precharge circuit 505 electrically interfaces with the user input 245, and in response to receiving a user input, electrically connects the battery pack 100 to the power boost module 480 to charge the power boost circuit 480 prior to the vehicle battery jump starter 300 being coupled to the vehicle battery 500. The method of controlling the precharge circuit 505 is detailed below in process 700 and illustrated in FIG. 7.

In some embodiments, the controller 400 includes a plurality of electrical and electronic components that provide power, operational control, and protection to the components and modules within the controller 400 and/or vehicle battery jump starter. For example, the controller 400 includes, among other things, a processing unit 435 (e.g., a microprocessor, a microcontroller, or another suitable programmable device), a memory 440, input units 445, and output units 450. The processing unit 435 includes, among other things, a control unit 455, an ALU 460, and a plurality of registers 465 (shown as a group of registers in FIG. 6), and is implemented using a known computer architecture, such as a modified Harvard architecture, a von Neumann architecture, etc. The processing unit 435, the memory 440, the input units 445, and the output units 450, as well as the various modules connected to the controller 400 are connected by one or more control and/or data buses (e.g., common bus 470). The control and/or data buses are shown generally in FIG. 6 for illustrative purposes. The use of one or more control and/or data buses for the interconnection between and communication among the various modules and components would be known to a person skilled in the art in view of the invention described herein. In some embodiments, the controller 400 is implemented partially or entirely on a semiconductor (e.g., an FPGA semiconductor) chip.

The memory 440 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 435 is connected to the memory 440 and executes software instructions that are capable of being stored in a RAM of the memory 440 (e.g., during execution), a ROM of the memory 440 (e.g., on a generally permanent basis), or another non-transitory computer readable medium such as another memory or a disc. Software included in the implementation of the vehicle battery jump starter can be stored in the memory 440 of the controller 400. The software includes, for example, firmware, one or more applications, program data, filters, rules, one or more program modules, and other executable instructions. The controller 400 is configured to retrieve from memory and execute, among other things, instructions related to the control processes and methods described herein. In other constructions, the controller 400 includes additional, fewer, or different components.

The battery pack interface 415 includes a combination of mechanical components (e.g., the support portion 310) and electrical components (e.g., the plurality of terminals 315) configured to and operable for interfacing (e.g., mechanically, electrically, and communicatively connecting) the vehicle battery jump starter with the battery pack 100. For example, power provided by the battery pack 100 to the vehicle battery jump starter is provided through the battery pack interface 415 to a power input module 410. The power input module 410 includes combinations of active and passive components to regulate or control the power received from the battery pack 100 prior to power being provided to the controller 400. The battery pack interface 415 also includes, for example, a communication line 475 for providing a communication line or link between the controller 400 and the battery pack 100. The battery pack interface 415 supplies power to the FET switching module 430 to be switched by the switching FETs to selectively provide power to the clamps 335, 340.

The FET switching module 430 is also connected to a power boost module 480. The power boost module 480 includes, for example, a plurality of supercapacitors or lithium-polymer battery cells. The power boost module 480 is selectively charged by the controller 400 with power from the battery pack 100. In some embodiments, the power boost module 480 is charged by a vehicle battery (e.g., supercapacitors can be charged from a depleted vehicle battery). The power boost module 480 can be used in conjunction with the battery pack 100 to provide power to a vehicle battery to jump start the vehicle battery. In some embodiments, the power boost module 480 alone (i.e., without battery pack 100) can be used to attempt to jump start a vehicle battery. Without the battery pack 100, however, the capabilities of the vehicle battery jump starter 300 are limited. For example, supercapacitors alone may not have the energy capacity to jump start a vehicle without the battery pack 100. Alternatively, lithium polymer battery cells require charging which may be difficult or impossible depending upon the location of the vehicle when its battery needs to be jump started.

In some embodiments, the vehicle battery jump starter 300 may include optimization features configured to be implemented by a charge control circuit 275. For example, before current is discharged from the battery pack 100, the charge control circuit 275 measures one or more parameters of the battery pack 100. In one embodiment, the parameter is a no-load voltage of the battery pack 100, which may be determined using, for example, the sensor 210. The measured battery pack voltage is then used by the charge control circuit 275 to calculate an allowable load voltage (also referred to as a threshold or a predetermined threshold) for the battery pack 100 when being discharged by the charge control circuit 275. In some examples the allowable load voltage is a predetermined voltage level.

In response to the allowable load being determined, the charge control circuit 275 then controls the vehicle battery jump starter 300 to draw current from the battery pack 100 until the allowable load level is reached. In some examples, the load level is determined based on a voltage drop during discharge. The charge control circuit 275 may prevent the vehicle battery jump starter 300 from drawing a current that would cause an undesired drop in voltage of the battery pack 100, e.g., below the load voltage threshold. In some embodiments, the charge control circuit 275 continues to measure the voltage of the battery pack 100 during discharge and modulates the discharge current in order to maintain the battery voltage at or above the allowable load voltage threshold. In some embodiments, the functions of the charge control circuit 275 are performed by the controller 400.

In some instances, the charge control circuit 275 may calculate the allowable load voltage threshold, or control the discharging of the battery pack 100, based upon the type of battery pack 100 connected. For example, when a low performing battery (e.g., a battery with high impedance) is connected to the vehicle battery jump starter 300, the allowable voltage threshold may be reached with a lower overall discharge current. On the other hand, when a high performing battery (e.g., a battery with low impedance) is connected to the vehicle battery jump starter 300, the allowable voltage threshold may be reached with a higher overall discharge current. In other words, a low performing battery pack may produce an overall lower discharge current, and therefore a longer charging time, than a high performing battery pack. The charge control circuit 275 is configured to control the vehicle battery jump starter 300 in order to maximize the efficiency of the connected battery pack 100, regardless of its performance level. In some examples, battery information, such as impedance, capacity, state of health, state of charge, temperature, etc., may be communicated by the battery controller 200 to the vehicle battery jump starter 300. In other examples, the battery information may be determined by the controller 400 and/or charge control circuit 275 upon the battery pack 100 being electrically coupled to the vehicle battery jump starter 300.

In some embodiments, the vehicle battery jump starter 300 may function as a charging device when connected with the battery pack 100. For example, the controller 400 of the vehicle battery jump starter 300 may be configured to communicate with the controller 200 of the battery pack to obtain battery specific information. The battery specific information may be, for example, a battery capacity level, an impedance level, a battery age, a battery temperature, a battery voltage level, or historical data such as a number of battery charge/discharge cycles, number of battery usages, or a number of battery overtemperature events. Once the battery specific information is obtained by the controller 400, the charge control circuit 275 may use some or all of the battery specific information to calculate an appropriate discharge current. For instance, as previously described, high/low performing batteries may have different impedance levels. The charge control circuit 275 may calculate the appropriate discharge current (and therefore the predetermined load voltage level) based upon the battery specific impedance level obtained from the battery pack 100.

In some embodiments, the vehicle battery jump starter 300 is configured to monitor characteristics of the battery pack 100 during operation. For example, the charge control circuit 275 is configured to monitor discharge characteristics of the battery pack 100 during operation of the vehicle battery jump starter 300 in order to predict behavior. In other words, the monitored characteristics are used by the charge control circuit 275 to determine optimal discharge rates for the battery pack 100. This prediction may also be used to determine whether the selected battery pack is a high or low performance battery (e.g., high or low impedance battery). Additionally, the charge control circuit 275 may use the predicted behavior to modulate the discharge rate of the battery pack 100. In some instances, the prediction utilizes machine learning to create a prediction profile for the battery pack 100. The prediction profile may contain historical data from previous uses of the battery pack 100 and is used by the charge control circuit 275 to determine the capabilities of the battery pack (e.g., the optimal discharge rates, the allowable voltage threshold, and the like).

In some embodiments, the vehicle battery jump starter 300 is configured to monitor the voltage level of the battery pack 100, as previously described, and adjusts the performance of elements within the vehicle battery jump starter 300 based upon the voltage of the battery pack 100 during discharge. For example, in response to the monitored voltage of the battery pack 100 being below the allowable voltage threshold, as previously described, the controller 400 may reduce power draw, extend a run time, modify performance of the power boost module 480, and/or perform other operations as required for a given application.

FIG. 7 is a flow chart illustrating a process 700 for operating the combination of battery pack 100 and vehicle battery jump starter 300. The process 700 begins with the battery pack 100 being attached to the vehicle battery jump starter 300 at process block 705. Following process block 705, the controller 400 of the vehicle battery jump starter 300 is configured to control the precharge circuit 505 to electrically connect the battery pack 100 to the power boost module 480 at process block 710. In response to the battery pack 100 being connected to the power boost module 480, one or more parameters of the connected battery pack 100 are determined at process block 712, as described in more detail above. In response to determining the parameters of the battery pack 100, stored energy from the battery pack 100 can be used to charge the power boost module 480 at process block 715 based upon the determined parameters. In some embodiments, the charge control circuit 275 regulates the current discharged from the battery pack 100 as previously described. In response to the power boost module 480 being fully charged, the controller 400 is configured to control the precharge circuit 505 to electrically disconnect the battery pack 100 from the power boost module 480 at process block 720. With the power boost module 480 charged and the battery pack 100 connected to the vehicle battery jump starter 300, the combination of the battery pack 100 and the vehicle battery jump starter can be used to jump start the vehicle battery 500.

The charge control circuit 275 can selectively prevent the battery pack 100 from being used to jump start the vehicle battery 500 if the voltage of the battery pack 100 is so low that attempting to jump start the vehicle battery 500 could damage the battery pack 100. For example, in addition to the allowable voltage threshold of the battery pack 100, a second allowable voltage threshold value can be implemented to prevent the battery pack 100 from being used to jump start a vehicle. In some examples, the charge control circuit 275 may prevent the battery pack 100 from discharging current when the battery pack's 100 voltage is below the second threshold value and discharging current would drop the voltage of the battery pack 100 below the second allowable voltage threshold (e.g., 2.6V per cell). The second voltage threshold value is selected to correspond to the amount of energy required to jump start the vehicle battery 500 or an expected voltage reduction resulting from the discharge of the high current necessary to jump start a vehicle battery. Where the battery pack 100 has less charge than would be required to jump start the vehicle battery 500, and attempting to jump start the vehicle battery 500 would cause the battery pack 100's voltage to be depleted below or fall below the standard low-voltage cutoff, charge control circuit 275 prevents the battery pack 100 from attempting to jump start the vehicle battery 500. In some embodiments, the controller 400 of the vehicle battery jump starter 300 or the controller 200 of the battery pack 100 may perform these functions.

The vehicle battery jump starter 300 is then connected to the vehicle battery 500 via terminal clamps 335 and 340 (at 725). In response to the vehicle battery jump starter 300 being connected to the vehicle battery 500, the controller 400 monitors the voltage across the vehicle battery 500 at process block 730). When an attempt to start a vehicle is made, the voltage of the vehicle battery 500 is reduced. This reduction in voltage of the vehicle battery 500 signals to the controller 400 that an attempt to start the vehicle has been made (at 735).

Thus, the invention provides, among other things, a vehicle battery jump starter powered by a removable and rechargeable battery pack.

What is claimed:

1. A vehicle battery jump starter device comprising:
a controller including an electronic processor and a charge control circuit;
a battery pack interface configured to receive a removable and rechargeable battery pack;
a power boost module including one or more energy storage devices;
wherein the power boost module is configured to be charged through the battery pack interface with a discharge current from the removable and rechargeable battery pack,
wherein the charge control circuit is configured to control the discharge current from the removable and rechargeable battery pack to the power boost module based upon one or more monitored conditions of the removable and rechargeable battery pack.

2. The device of claim 1, wherein the charge control circuit is configured to measure a no-load voltage of the removable and rechargeable battery pack and calculate an allowable load voltage threshold based on the measured no-load voltage.

3. The device of claim 1, wherein the charge control circuit is configured to control the discharge current from the removable and rechargeable battery pack to the power boost module to maintain a voltage of the removable and rechargeable battery pack above an allowable load voltage threshold.

4. The device of claim 3, wherein the charge control circuit is configured to modulate the discharge current to maintain the voltage of the removable and rechargeable battery pack at or above the allowable load voltage threshold.

5. The device of claim 2, wherein the charge control circuit calculates the allowable load voltage threshold based upon a type of removable and rechargeable battery pack, the type of removable and rechargeable battery pack including a high impedance battery pack or a low impedance battery pack.

6. The device of claim 5, wherein the charge control circuit determines the type of removable and rechargeable battery pack based on battery information communicated from the removable and rechargeable battery pack.

7. The device of claim 5, wherein the charge control circuit determines the type of removable and rechargeable battery pack based on monitored discharge characteristics of the battery pack.

8. The device of claim 1, wherein the controller is configured to prevent the removable and rechargeable battery pack from being used to jump start the vehicle battery if a voltage of the removable and rechargeable battery pack is below a second allowable voltage threshold.

9. The device of claim 1, wherein the power boost module includes a plurality of supercapacitors and/or a plurality of lithium-polymer battery cells.

10. A method of jump starting a vehicle battery using a vehicle battery jump starter and a removable and rechargeable battery pack, the method comprising:
electrically connecting the removable and rechargeable battery pack to a power boost module within the vehicle battery jump starter;
determining, via a first electronic processor of the removable and rechargeable battery pack, one or more parameters of the removable and rechargeable battery pack;
charging, via the first electronic processor, the power boost module using power from the removable and rechargeable battery pack based on the determined parameters;
electrically disconnecting, via the first electronic processor, the removable and rechargeable battery pack from the power boost module after the power boost module is charged;
electrically connecting the vehicle battery jump starter to the vehicle battery;
monitoring, via a second electronic processor, a voltage of the vehicle battery; and
controlling, via the second electronic processor, power from the charged power boost module to the vehicle battery in response to the voltage of the vehicle battery indicating an attempt to start the vehicle.

11. The method of claim 10, further comprising:
preventing, via the second electronic processor, the removable and rechargeable battery pack from being used to jump start the vehicle battery if the voltage of the removable and rechargeable battery pack is below a voltage threshold.

12. The method of claim 10, wherein determining the one or more parameters of the connected removable and rechargeable battery pack includes measuring a no-load voltage of the removable and rechargeable battery pack, and calculating, via the first electronic processor, an allowable load voltage threshold based on the measured no-load voltage.

13. The method of claim 12, further comprising:
controlling, via the first electronic processor, a discharge current from the removable and rechargeable battery pack to the power boost module to maintain the voltage of the removable and rechargeable battery pack above the allowable load voltage threshold.

14. The method of claim 13, further comprising:
modulating, via the first electronic processor, the discharge current to maintain the voltage of the removable and rechargeable battery pack at or above the allowable load voltage threshold.

15. A battery pack powered vehicle battery jump starter system, the system comprising:
a removable and rechargeable battery pack including:
a battery pack housing;
a plurality of rechargeable battery cells within the battery pack housing;
a support portion for supporting the battery pack on the vehicle battery jump starter;
a coupling mechanism for selectively electrically coupling the removable and rechargeable battery pack to the vehicle battery jump starter;
a battery pack controller within the battery pack housing, the battery pack controller configured to control an operation of the removable and rechargeable battery pack; and
a vehicle battery jump starter including:
a jump starter housing;
a support portion for receiving and coupling the removable and rechargeable battery pack to the vehicle battery jump starter;
a plurality of terminals for electrically connecting the removable and rechargeable battery pack to the vehicle battery jump starter; and
a jump starter controller within the jump starter housing, the jump starter controller configured to control an operation of the vehicle battery jump starter;
wherein the jump starter controller controls the vehicle battery jump starter to jump start a vehicle in response to the battery pack controller controlling an operation of the removable and rechargeable battery pack.

16. The system of claim 15, wherein the battery pack controller is configured to communicate battery pack information to the jump starter controller, and the jump starter controller is configured to use the communicated battery pack information to control the operation of the vehicle battery jump starter, and
wherein the battery pack information includes one selected from a group consisting of a battery capacity level, a battery impedance level, a battery age, a battery temperature, a battery voltage level, a number of battery charge/discharge cycles, a number of battery usages, and a number of battery overtemperature events.

17. The system of claim 15, wherein the jump starter controller is configured to monitor discharge characteristics of the removable and rechargeable battery pack during operation of the vehicle battery jump starter and predict a discharge rate of the removable and rechargeable battery pack based on the monitored discharge characteristics.

18. The system of claim 15, wherein the jump starter controller is configured to adjust performance of the vehicle battery jump starter in response to a monitored voltage of the removable and rechargeable battery pack being below an allowable load voltage threshold, and
wherein adjusting the performance includes one selected from a group consisting of reducing a power draw, extending a run time, and modifying a performance of a power boost module within the vehicle battery jump starter.

19. The system of claim 15, wherein the jump starter controller is configured to prevent the removable and rechargeable battery pack from being used to jump start a vehicle battery in response to a voltage of the removable and rechargeable battery pack being below a second allowable voltage threshold.

20. The system of claim 15, wherein the vehicle battery jump starter further includes a power boost module having one or more energy storage devices,
wherein the jump starter controller is configured to charge the power boost module using power from the removable and rechargeable battery pack, and
wherein the jump starter controller controls the charging of the power boost module based on one or more parameters of the removable and rechargeable battery pack.
